(19) United States
(12) Patent Application Publication
(10) Pub. No.: US 2023/0202829 A1
(43) Pub. Date: Jun. 29, 2023

(54) SADDLE PAD WITH LOAD BEARING INTERFACE

(71) Applicant: Jacqueline Fenaroli, San Jacinto, CA (US)

(72) Inventor: Jacqueline Fenaroli, San Jacinto, CA (US)

(21) Appl. No.: 18/116,741

(22) Filed: Mar. 2, 2023

Related U.S. Application Data
(63) Continuation-in-part of application No. 17/547,577, filed on Dec. 10, 2021.
Application No. 17/547,577 is a continuation-in-part of application No. 16/128,577, filed on Sep. 12, 2018, now Pat. No. 11,299,389.
(60) Provisional application No. 62/557,326, filed on Sep. 12, 2017.

(51) Int. Cl. B68C 1/12

(52) U.S. Cl. CPC B68C 1/12

(57) ABSTRACT

A cassette to be inserted in a saddle pad pocket, having one or more multiple aligned rigid elements that independently teeter totter about a fulcrum under a conventional saddle, creating an instantly morphing interface to match the dynamic shape of the horse’s back in order to better distribute the weight of a rider and reduce peak pressures as the horse moves.

### CROSS-REFERENCE TO RELATED APPLICATIONS

The present application claims priority under 35 U.S.C. 120 and all applicable U.S. statutes and regulations to U.S. Application Serial No. 16/128,577, filed Sep. 12, 2018. That U.S. Application Serial No. 16/128,577 previously claimed priority under 35 U.S.C. 119(e) to U.S. Provisional Application Serial No. 62/557,326 filed Sep. 12, 2017. Some of the claims of Serial No. 16/128,577 matured into U.S. Pat. No. 11,299,389 B2, filed on Apr. 12, 2022. The remaining claims became a continuation-in-part of U.S. Application No. 17/547,577 filed on Dec. 10, 2021. On request for restriction, a second continuation-in-part is now being submitted. All of the above disclosures are incorporated herein by reference in its entirety.

### FIELD OF THE INVENTION

A saddle should be comfortable for both horse and rider. A cushioned saddle pad fits under the saddle and assists in providing comfort for horse and rider. The invention relates to distribution of a rider’s weight on a horse, where a cassette of multiple aligned rigid elements (sometimes referred to as “rigid elements” or “rigid element”) are inserted into a saddle pad which is positioned under a saddle, and where each rigid element in the cassette can tip about a fulcrum independently of its neighboring rigid elements to reshape the interface instantly and match the shape of the horse’s back at rest, and then reshape the interface instantly again to match the horse’s back when in motion for each stride that the horse takes.

### BACKGROUND OF THE INVENTION

It is accepted that there are meaningful differences between horses in size and shape. It is accepted that a particular horse’s back may change shape with weight gain or loss, movement, conditioning, health, training, rider weight and equitation habits.

In the current state of the art, many saddles have rigid frames. A significant disadvantage is that a rigid frame saddle may fit a particular horse poorly and that could create pressure points, where there are areas of concentrated pressure causing chaffing, pain and/or sores to develop on the horse. The goal of fitting a saddle is to ensure the weight of the rider is distributed over as large a foot print as possible on the horse’s back without causing pressure points.

Attempts to custom fit rigid frames on horses present problems in that the same rigid frame cannot be used for horses of different dimensions without creating pressure points on one of the horses. Another complication with rigid frames is that any rider who rides multiple horses with different shapes and sizes incurs undue expense because he or she would have to acquire multiple saddles. Another complication is that horses change shape over time which can cause saddle misfits with high pressure points.

In the current state of the art, to fit saddles to horses requires expertise, experience and considerable effort. A typical saddle includes: a base frame or “tree” with a seat for the rider; on a Western saddle, bars, and on an English saddle, panels, on the bottom of the saddle which protect the horse from the rider’s seat and protect the rider’s seat from the horse; a saddle pad under the saddle; a girth that fits around the underbelly of the horse and keeps the saddle stable; and stirrups for the rider’s feet.

On a typical English saddle, at an interface with the horse, there are panels with cushions that provide a padded surface for the horse’s back while raising the tree high enough to clear the horse’s spine. The same is true for a dressage saddle, which looks like an English saddle, but has a different purpose. On a typical Western saddle, at an interface with the horse, there are rigid bars on top of the cushioned saddle pads that provide the same function as on the English saddle. These typically cushioned pads help protect the horse’s back from the hardness of the saddle, but they cannot distribute the rider’s weight evenly both in motion and at rest, because they lack a load bearing structure that can reshape to match the horse’s back.

The present invention addresses the absence of a morphing or load bearing structure, by providing a cassette of multiple aligned rigid elements inserted into a saddle pad and placed directly on the horse’s back beneath a typical Western saddle, an English saddle, a dressage saddle, or even a treeless saddle. The rigid elements tip on a fulcrum, which fulcrum runs roughly parallel to the ground, along two lateral sides under the saddle. Multiple rigid elements are aligned so they are free to independently tip about the fulcrum, instantly morphing the interface to match the shape of the horse’s back in motion, and that allows for improved distribution of the load of the rider’s weight.

### SUMMARY OF THE INVENTION

### Definitions

The “saddle pad pocket” is a reference to a saddle pad which can accommodate the insertion of a load bearing structure; a slit in the saddle pad with a bag of the same material sewn into the saddle pad. There is one saddle pad pocket on each side of the saddle pad, so each saddle pad can accommodate two cassettes.
The load bearing structure is a cassette.
The trade name for the cassette which is comprised of aligned rigid elements that can independently tip on a fulcrum and can be inserted into a saddle pad pocket is Living Bar® Cassette. The trade name is used for convenience.
The trade name of a thinner version of the Living Bar® Cassette with a raised ridge added to the upper surface of the cassette which roughly runs along the midline of the cassette is the Living Bar® Slimsert Cassette [hereafter “Slimsert]. The trade name is used for convenience.
“Cassette” is sometimes used interchangeably to refer to either the Living Bar® Cassette or Slimsert.

The invention overcomes the problem of uneven load distribution on a variable surface (the horse’s back) by providing a direct load path from a rider’s concentrated downward force through a saddle on top of a saddle pad which has the Living Bar® Cassette or the Slimsert inserted into saddle pad pocket on each side of the horse.

It is an object of this invention to provide a load bearing structure for use on the back of a horse whereby localized load pressure points are eliminated, and whereby load is distributed more evenly over the entire load bearing footprint of the saddle pad.

The invention is a cassette composed of two or more rigid elements that independently tip on a fulcrum, so as to teeter-totter as the horse moves, instantly morphing the interface to match the horse’s back.

It is an object of this invention to create a saddle pad with a load bearing structure that instantly reshapes to fit the horse’s back without the effort or expertise of a saddle fitter.

### BRIEF DESCRIPTION OF DRAWINGS

FIG. 1 is a side view of a horse’s back, showing the location of a saddle pad under a typical western saddle (which saddle is not part of the invention).

FIG. 2 is a plan view of one side of a cassette showing multiple aligned rigid elements, which independently tip on a fulcrum so as to teeter-totter under the bars or panels of a conventional saddle as the horse moves.

FIG. 3 is a plan view of an embodiment of a Living Bar® Cassette inserted into a saddle pad pocket showing the placement of multiple aligned rigid elements, which independently tip on a fulcrum under a saddle bar or panel within a cushioned saddle pad.

FIG. 4 is a plan view of an embodiment of a Slimsert inserted into a saddle pad pocket showing the placement of multiple aligned rigid elements, which independently tip on a fulcrum raised ridge, within a cushioned saddle pad.

FIG. 5 is a pressure map of a scan of a horse’s back showing higher pressure areas under load with conventional saddle on top of a saddle pad without the invention inserted into the saddle pad pockets.

FIG. 6 is a pressure map of a scan of a horse’s back showing reduced peak pressure areas under load with conventional saddle on top of a saddle pad with the Living Bar® Cassette inserted into the saddle pad pockets.

FIG. 7 is a pressure map of a scan of a horse’s back showing further reduced peak pressure areas under load with conventional saddle on top of a saddle pad with the Slimsert inserted into the saddle pad pockets.

FIG. 8 is a front view of a typical Western saddle tree with the current embodiment of a single rigid element positioned so that its approximate midpoint contacts the crown of the Western saddle tree bar acting as a fulcrum.

### DETAILED DESCRIPTION OF THE PREFERRED EMBODIMENTS

The following detailed description and accompanying drawings are provided for purposes of illustrating and describing presently preferred embodiments of the present invention and are not intended to limit the scope of the invention in anyway.

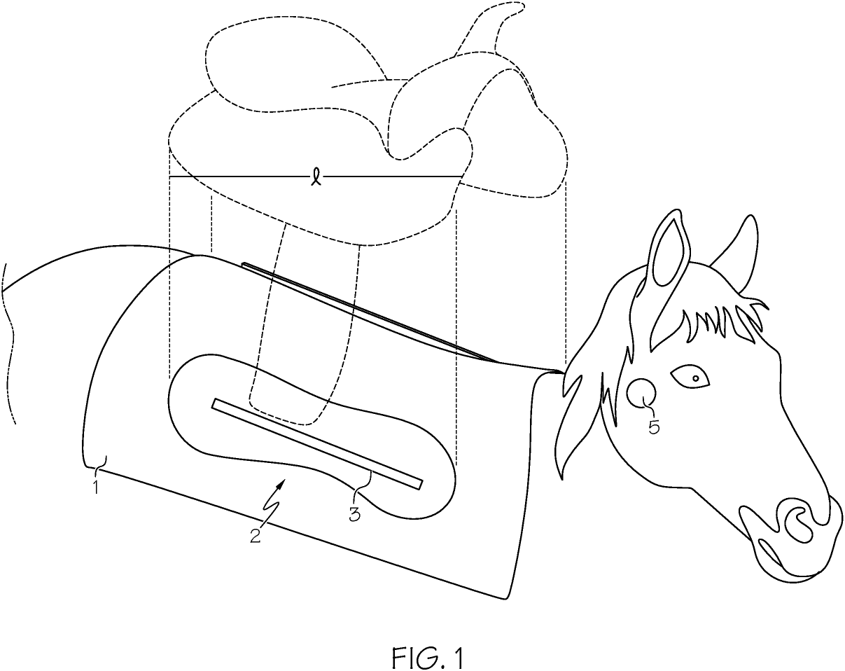

In FIG. 1, a saddle pad [1] with cassette inserted [2] is shown at an interface with a horse [5]. Under cushioning there is a thickened midline that is a fulcrum [3] running almost the entire length of the cassette on each side, about which fulcrum, multiple rigid elements within the cassette [2] are independently able to tip so they can teeter-totter as the horse moves. Each rigid element moves independently from the other neighboring rigid elements, allowing the assembly to form a load bearing structure which rehapes or morphs to match a surface on the horse’s back as the horse moves. By morphing to the surface on the horse’s back, the rider’s weight is evenly distributed over a larger foot print, reducing pressure points.

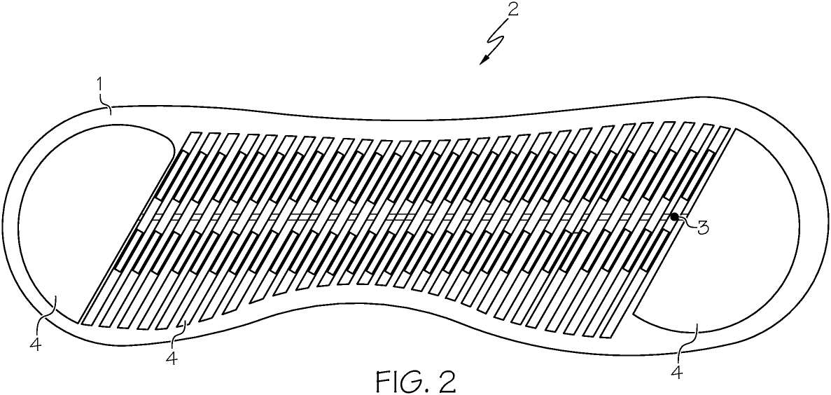

FIG. 2 shows an embodiment of a cassette [2] which can be inserted into a saddle pad pocket on the saddle pad [1], where there are two saddle pad pockets one for each side of the horse. The multiple rigid elements [4] are pivotally connected to the fulcrum [3].

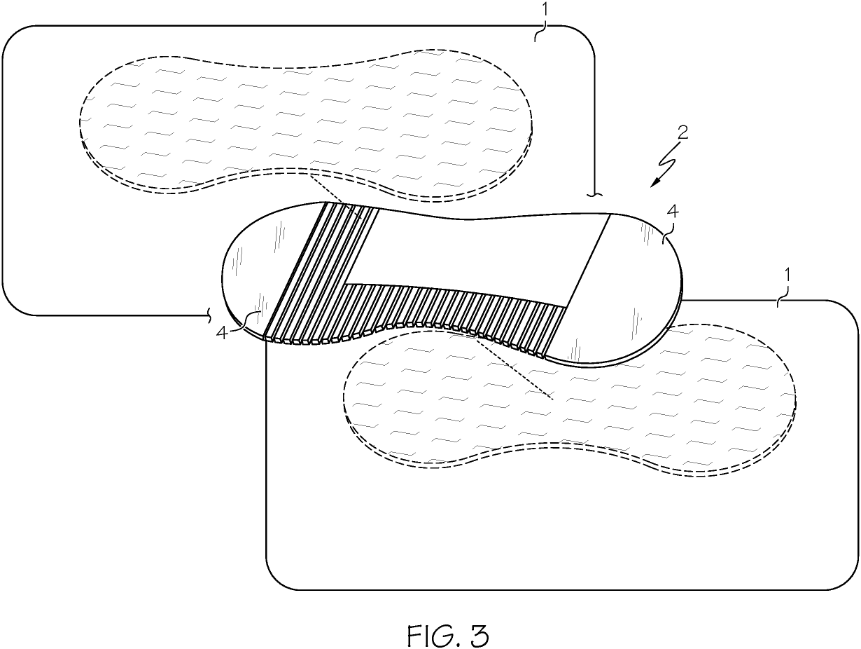

FIG. 3 is an exploded view showing an embodiment of the Living Bar® Cassette inserted into a pocket in the saddle pad [1]. The Living Bar® Cassette [2] has multiple rigid elements [4] which can independently tip under a Western saddle bar or English saddle panel.

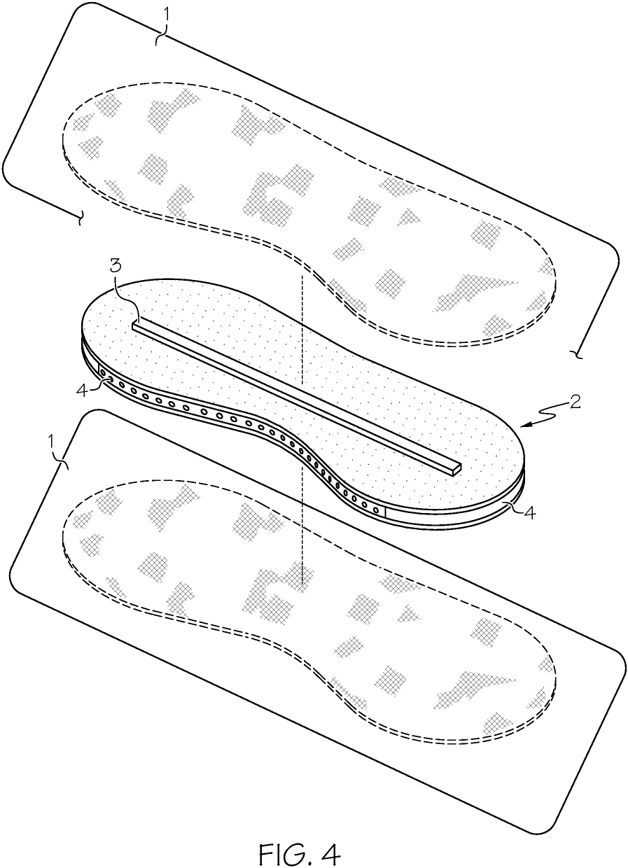

FIG. 4 is an exploded view showing an embodiment of the Slimsert [2] inserted into a pocket in the saddle pad [1]. The Slimsert has multiple rigid elements [4] and a raised fulcrum [3], where the multiple rigid elements can independently tip about the fulcrum [3].

The rigid elements inside the cassette can be comprised of rods, tubes, fingers or plates of various shapes and orientations and numbers, and can be fabricated from different materials including composites, metal, wood or plastic of sufficient rigidity. The rigid elements can be held in planar relation to each other by a variety of methods including encasement, pinning along midline area, nesting in flexible materials, injection molding of an assembly, attachment to an axle, or even partially cut from a whole sheet. One advantage of the saddle pad pocket with a cassette inserted on each side of the saddle pad over a saddle having the same invention, is that the saddle pad is significantly less costly for the user to purchase than a saddle.

Objective tests were performed to confirm the hypothesis that a saddle pad with a cassette inserted into a cushioned material (either the Living Bar® cassette or Slimsert) will better distribute the load on a horse’s back under a conventional saddle, than a saddle pad without the inserted cassette.

Reasonable standards for load measurement testing on the horse’s back are: (1) Measured pressures from saddle and rider on the horse should not exceed a mean arterial blood pressure of 115 mm Hg (equivalent to 2.2 psi) for extended periods of time to avoid impeding blood flow and damaging tissue. (2) Because the projected horizontal area available for loading is reduced around the horse’s acutely angled withers when compared to its broader loin, loading is typically higher towards the front of the saddle than over the rear. (3) Dynamic loads on the horse should be distributed and not concentrated to avoid bruising horse flesh by minimizing peak pressures. (4) The saddle should remain stationary on the horses back, and (5) the saddle should not impede movement.

The goals of testing are: (1) Fabricate and test Living Bar® Cassette and Slimsert inserted into a saddle pad and demonstrate functionality when ridden under a saddle. (2) Comparison pressure map a rigid treed, Western saddle, ridden with and without Living Bar® Cassette or Slimsert inserted into a saddle pad. And, (4) evaluate the results for potential benefits to horse and rider.

The materials and equipment for testing are: (1) Western treed saddle; (2) saddle pad with pockets to accommodate inserted cassettes; (3) Living Bar® Cassette; (4) Slimsert cassette; and (5) BodiTrak pressure mapping system, which is a name brand for a piezoelectric blanket with WiFi capability able to transfer data to a computer monitor.

Test procedures are: (1) A known horse and saddle combination was selected for this testing. The selected saddle could occasionally cause fist size, dry spots on either side of the horse’s withers depending upon pad use, type and length of riding. No soreness, edema or other affects such as horse protesting were ever detected and the dry spots were of modest concern. (2) The horse was tacked as typical with a rigid treed Western saddle, and using a pocketed saddle pad with ⅜” wool felt sheet trimmed, and inserting a cassette into the saddle pad pocket on each side of the saddle pad. (3) The saddle pad was then placed on top of a BodiTrak pressure sensing mat and ⅜” wool underlayment. This stack of materials and equipment was repeated throughout the testing with substitutions of different cassettes being inserted into the saddle pad pockets only as noted below.

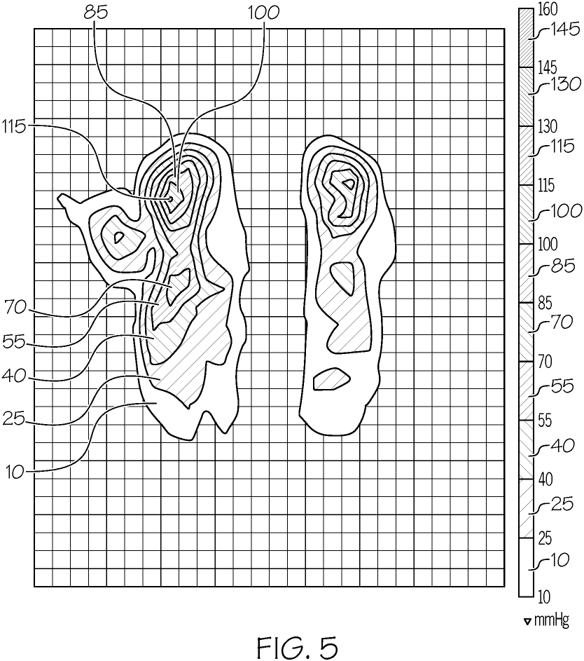

In the first test, a rider mounted the horse without inserting any cassette, and pressure readings were recorded live while stationary after a short walk. FIG. 5 shows the results of the testing. Notably, the color reading of the BodiTrak correlated to pressure areas, where: white [10] reflected minimal pressure; blue [25] reflected the lowest pressure on the horse’s back ranging from 25-40 mm HG; blue-green [40] reflected slightly higher pressure ranging from 40-55 mm HG; green-blue [55] reflected still higher pressure ranging from 55-70 mm Hg; green-yellow [70] reflected still higher pressure ranging from 70-85 mm Hg; yellow [85] reflected a cautionary pressure ranging from 85-100 mm Hg; yellow-orange [100] reflected likely point of possible pain on prolonged usage, with pressure ranging from 100-115 mm Hg; and orange [115] reflected a danger point at 115 mm Hg and above, which would likely result in “white hair syndrome” which is associated with restricted blood flow to hair coat follicles.

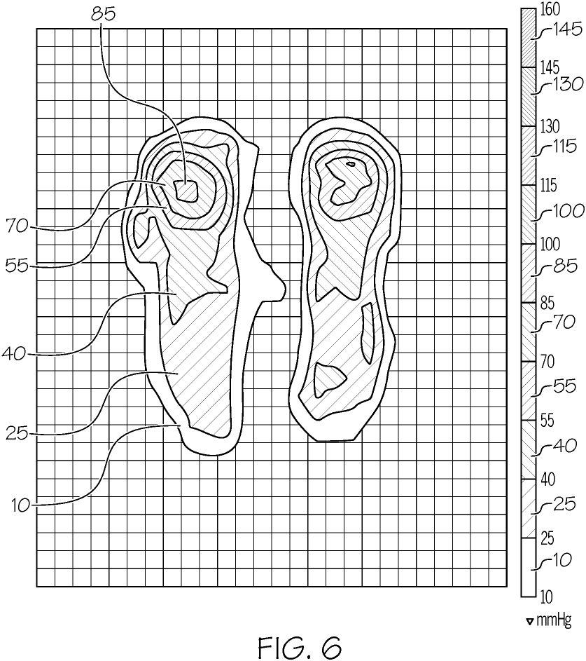

The second test involved untacking the horse and retacking using the Living Bar® Cassette inserted into the saddle pad pocket. Then with the same rider and Western saddle, loads were mapped while stationary after a short walk using the BodiTrak. The results are shown on FIG. 6. The same scale of mm HG reveals that the results were clearly better than using a saddle pad without any cassette inserted, since peak pressures were reduced to 25-85 mm Hg, well below the cautionary range.

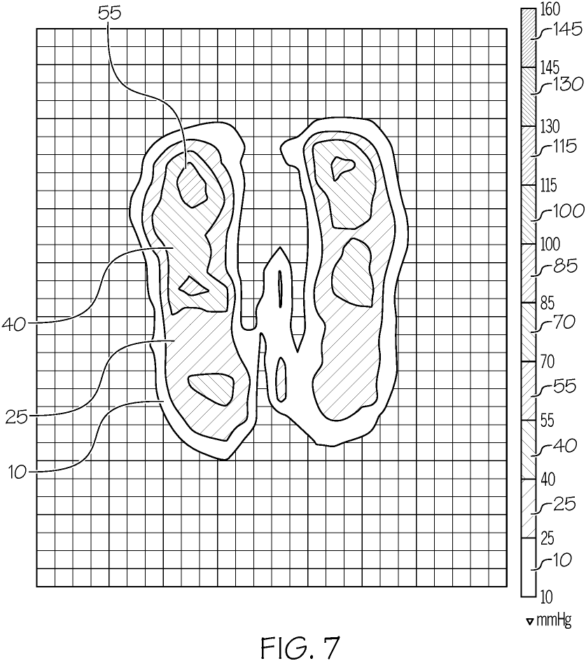

The third test involved untacking the horse and retacking using the Slimsert inserted into the saddle pad pocket. Then with the same rider and Western saddle, loads were mapped while stationary after a short walk using the BodiTrak. Only three colors were reported on the BodiTrak using the same scale of mm Hg, that being blue, blue-green, and green-blue. FIG. 7 shows the results of the testing: blue [25] reflected the lowest pressure on the horse’s back ranging from 25-40 mm HG; blue-green [40] reflected slightly higher pressure ranging from 40-55 mm HG; and, green-blue [55] reflected a peak pressure ranging from 55-70 mm Hg.

Discussion of test results: (1) All tests rides were performed without incident and the horse appeared unreactive to the equipment, the saddle remained stationary and felt stable to the rider during all tests. Therefore, the Living Bar® Cassette and Slimsert were found to be functional. The low profile Slimsert was preferred by the rider because it allowed closer contact with the horse. (2) Pressure mapping of the Western saddle and saddle pad without inserts at FIG. 5, showed flashes of warning yellow colors and warmer colors, meaning pressures at or over 115 mm Hg, over a palm sized area on either side of the horse’s withers known to have historic dry spots dependant upon riding conditions. The corroboration of testing results showing elevated pressures over an area with known history of dry sweat patterns gave confidence that the pressure readings were meaningful. (3) Pressure mapping of the Living Bar® Cassette and Slimsert showed an improvement in pressure distribution by increasing the footprint area and thereby reducing peak loads in comparison to the saddle and saddle pad without cassette inserted. Further, pressures over the area at the withers prone to dry spots were reduced by more than half, when the cassettes were inserted into the saddle pad pockets. (4) The Slimsert performed best at FIG. 7 -with lowest peak loads. This result is likely due to the fulcrum providing a larger range of tipping motion for the multiple rigid elements than afforded by the Western saddle tree bar’s transverse crown acting as a defacto fulcrum. The Slimsert also showed an improvement in pressure distribution by spreading and moving loads rearward and away from the shoulders.

Conclusion of testing: Live pressure mapping of a saddle while stationary and at the walk, showed better load distribution and reduction of peak pressure with both types of cassettes inserted into the saddle pad by shifting loads rearward and spreading loads away from the horse’s shoulders, compare FIG. 7 [saddle pad with invention] to FIG. 5 [saddle pad without invention]. The Slimsert increased the Western saddles footprint by 13%, reduced peak loads by more than half, and improved distribution by spreading loads away from the shoulder area and rearward towards the loins.

The application presents a cassette inserted into a saddle pad to be placed under a conventional saddle comprising: a cushioned material in a roughly rectangular shape which can be placed on a horse’s back; a cassette comprising a fulcrum running almost the entirety of its midline length of the saddle pad; a parallel series of rigid elements able to tip under the fulcrum, so that the rigid elements can move independently from one another; the rigid elements are held in planar relation to one another when static, but when contact from the saddle is made with each rigid element, then each rigid element can be caused to tip out of plane about the fulcrum until they lay along side the horse; and, wherein as the horse moves the elements provide a passively morphing load bearing interface to match the changing surfaces of the horse’s back.

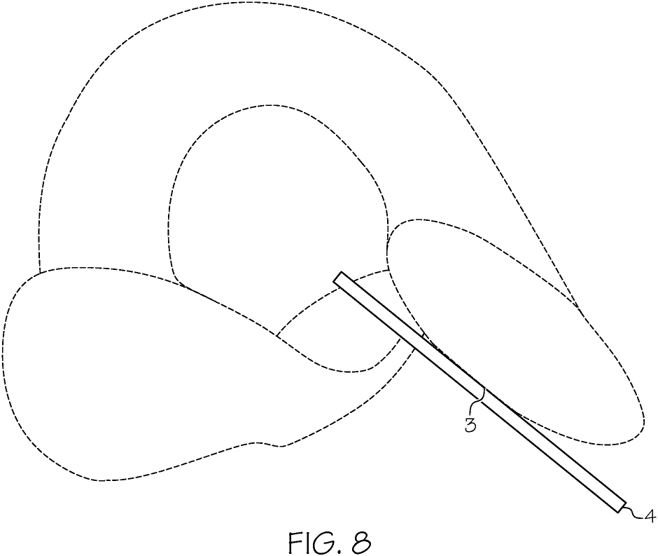

FIG. 8 is a front view of the underside of a typical Western saddle tree with the current embodiment of a single rigid element [4] positioned so that its approximate midpoint contacts the crown of the Western saddle tree bar acting as a fulcrum [3].

The fulcrum [3] in FIG. 1, can be created within the saddle pad by various means. The multiple rigid elements within the cassette [2] can be aligned inside the saddle pad [1] by means of encapsulation, molded to the fulcrum, pinned, or assemblies of various types.

The saddle may be selected from the group comprising chassis, equine saddle, saddle tree, treeless saddle, Australian saddle, English saddle, dressage saddle, or Western saddle.

The multiple aligned rigid elements [4] in FIG. 3, can be held in place in the saddle pad by various means, including sewn in place.

In FIG. 2, the fulcrum [3] and the multiple aligned rigid elements [4] form a structure which can morph to reshape to match the horse’s back in motion. The rigid elements are not flexible, and are constrained in all directions except tipping on the fulcrum [3].

The rigid elements can be assembled between one or more foam spacers, end caps, and side walls. The rigid elements can also be sandwiched between a top foam sheet and a bottom foam sheet.

1. A saddle pad to be placed under a conventional saddle comprising:
a cushioned material in a roughly rectangular shape, with two saddle pad pockets one for each side, which can be placed on a horse’s back;
a cassette comprised of multiple aligned rigid elements that tip on a fulcrum which fulcrum runs almost the entire length of the cassette, so that the rigid elements are parallel to and abut one another, and can move independently from one another as they teeter-totter on the fulcrum;
where one cassette can be inserted into each of the two saddle pad pockets; and,
wherein as the horse takes each stride the rigid elements tip on the fulcrum providing a passively morphing interface to match the changing surfaces of the horse’s back.

2. The saddle pad of claim 1, wherein the rigid elements may be of one or more materials selected from the group comprising composite fiber, plastic, steel, aluminum, glass, wood or metal alloy.

3. The saddle pad of claim 1, wherein the rigid elements may be held in planar relation to each other by a variety of methods selected from the group comprising encasement, pinning along midline area, nesting in flexible materials, molding in an assembly, attached to an axle, balls and sockets, or even partially cut from a whole sheet.

4. The saddle pad of claim 4, wherein the rigid elements are positioned between one or more foam spacers, end caps, and side walls.

5. The saddle pad of claim 1, where the rigid elements are sandwiched between a top foam sheet and a bottom foam sheet.
